(19) United States
(12) Patent Application Publication
(10) Pub. No.: US 2025/0256496 A1
(43) Pub. Date: Aug. 14, 2025

(54) SUPPORT COMPONENT AND LAMINATION DEVICE

(71) Applicant: Yungu (Gu’an) Technology Co., Ltd., Langfang (CN)

(72) Inventors: Zeming YANG, Langfang (CN); Zhipeng XU, Langfang (CN); Yuanyuan CHEN, Langfang (CN); Liubin FAN, Langfang (CN); Mingxing LIU, Langfang (CN); Jingjing ZHAO, Langfang (CN)

(73) Assignee: Yungu (Gu’an) Technology Co., Ltd., Langfang (CN)

(21) Appl. No.: 19/193,903

(22) Filed: Apr. 29, 2025

Related U.S. Application Data
(63) Continuation of application No. PCT/CN2023/090877, filed on Apr. 26, 2023.

(30) Foreign Application Priority Data
Nov. 24, 2022 (CN) 202211480203.6

(51) Int. Cl. B32B 37/00; B32B 37/10

(52) U.S. Cl. CPC B32B 37/0046; B32B 37/10; B32B 2457/20

(57) ABSTRACT

The embodiments of the present application provide a support component and a lamination device. The support component is configured to laminate a curved cover plate with a flexible screen, and the support component includes: a flexible support table configured to support the flexible screen; and a base arranged on a side of the flexible support table in a first direction and configured to support the flexible support table, and the flexible support table includes a central area and first edge areas located on two sides of the central area in a second direction, the base includes first abutting portions, and at least part of the first edge area abuts against and between two of the first abutting portions that are arranged oppositely in a third direction, the first direction, the second direction, and the third direction intersecting each other.

### CROSS-REFERENCE TO RELATED APPLICATIONS

The present application a continuation of International Application No. PCT/CN2023/090877 filed on Apr. 26, 2023, which claims priority to Chinese Patent Application No. 202211480203.6, filed on Nov. 24, 2022. All of the aforementioned patent applications are hereby incorporated by reference in their entireties.

### FIELD

The present application relates to the field of flexible screen lamination equipment, and in particular to a support component and a lamination device.

### BACKGROUND

With the advent of the ubiquitous screen era, people's demand for full screens is becoming stronger and stronger. In order to increase the screen-to-body ratio, dual-curved lamination technology and quad-curved lamination technology have emerged.

In the prior art, the flexible characteristics of the flexible screen are mainly used to achieve a full screen. At present, the lamination methods for the flexible screen are mainly to use a silicone pad to press the flexible screen to an inner side of a glass curved cover plate. During lamination, the silicone pad is deformed due to the pressures from upper and lower jigs, to complete the lamination of the flexible screen with the curved cover plate. When an insufficient force is exerted by the silicone pad on the flexible screen, it is possible to cause bubbles between the flexible screen and the curved cover plate.

### SUMMARY

Embodiments of the present application provide a support component and a lamination device, which are intended to solve the problem of the generation of bubbles during lamination of a flexible screen with a curved cover plate.

In an aspect, the embodiments of the present application provide a support component for laminating a curved cover plate with a flexible screen, the support component including: a flexible support table configured to support the flexible screen; and a base arranged on a side of the flexible support table in a first direction and configured to support the flexible support table, wherein the flexible support table includes a central area and first edge areas located on two sides of the central area in a second direction, the base includes first abutting portions, and at least part of the first edge area abuts against and between two of the first abutting portions that are arranged oppositely in a third direction, the first direction, the second direction, and the third direction intersecting each other.

In a second aspect, the embodiments of the present application further provide a lamination device configured to laminate a curved cover plate with a flexible screen, the lamination device including a support component according to any of the above embodiments of the first aspect, and a pressing table, the pressing table being arranged on one side of the support component, the pressing table having a receiving recess for receiving the curved cover plate, and an opening of the receiving recess facing the support component.

The support component provided in the embodiments of the present application is configured to support the flexible screen during the lamination of the curved cover plate with the flexible screen. The flexible support table includes a central area and first edge areas, the first edge areas being more susceptible to deformation relative to the central area. At least part of the first edge area abuts against and between two of the first abutting portions that are arranged oppositely in a third direction, and the first abutting portions can provide the first edge area with limiting forces facing each other in the third direction, so that the problem of insufficient force exerted by the first edge area on the flexible screen due to excessive deformation of the first edge area can be alleviated, and the problem of lamination bubbles between the curved cover plate and the flexible screen can thus be alleviated.

### BRIEF DESCRIPTION OF THE DRAWINGS

FIG. 1 is a structural schematic view of a curved cover plate and a flexible screen which are laminated by using a lamination device according to an embodiment of the present application;

FIG. 2 is a structural schematic perspective view of a support component according to an embodiment of the present application;

FIG. 3 is a top view of a flexible support table of a support component according to an embodiment of the present application;

FIG. 4 is a structural schematic perspective view of a support component according to another embodiment of the present application;

FIG. 5 is a structural schematic perspective view of a base of a support component according to another embodiment of the present application; and

FIG. 6 is a structural schematic perspective view of a support component according to still another embodiment of the present application;

FIG. 7 is a structural schematic perspective view of a support component according to still another embodiment of the present application;

FIG. 8 is a structural schematic view of a stopper of a support component according to still another embodiment of the present application;

FIG. 9 is a structural schematic perspective view of a support component according to yet another embodiment of the present application;

FIG. 10 is a structural schematic perspective view of a flexible support table of a support component according to yet another embodiment of the present application;

FIG. 11 is a structural schematic perspective view of a base of a support component according to yet another embodiment of the present application; and

FIG. 12 is a structural schematic view of a lamination device according to an embodiment of the present application.

### DETAILED DESCRIPTION OF EMBODIMENTS

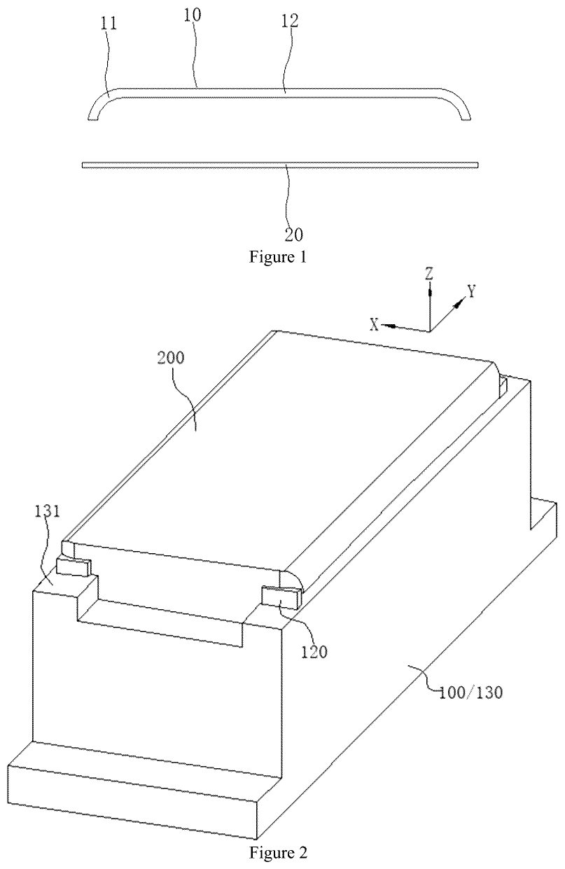

As shown in FIG. 1, FIG. 1 shows a structural schematic exploded view of a display device including a flexible screen 20 and a curved cover plate 10 which are laminated with each other. The curved cover plate 10 includes a flattened portion 12 and a specially-shaped portion 11 located on at least one side in a circumferential direction of the flattened portion 12. The specially-shaped portion 11 is bent with respect to the flattened portion 12, and the flexible screen 20 is laminated with the flattened portion 12 and the specially-shaped portion 11 so that the specially-shaped portion 11 is also available for display, thereby increasing the screen-to-body ratio of the display device.

During the lamination of the flexible screen 20 with the curved cover plate 10, the flexible screen 20 is generally arranged on a deformable flexible support table 200, such that the flexible screen 20 can be better laminated with the specially-shaped portion 11 of the curved cover plate 10 by means of the deformation of the flexible support table 200. In the prior art, since the shape of the specially-shaped portion 11 is irregular, the specially-shaped portion 11 has a specially-shaped curved surface, resulting in lamination bubbles between the specially-shaped portion 11 and the flexible screen 20.

In order to solve the above problem, the present application is filed. In order to better understand the present application, a support component and a lamination device according to the embodiments of the present application will be described in detail below with reference to FIGS. 2 to 12.

Referring to FIG. 2, FIG. 2 is a structural schematic perspective view of a support component according to an embodiment of the first aspect of the present application.

As shown in FIG. 2, the embodiments of the first aspect of the present application provide a support component for laminating a curved cover plate 10 with a flexible screen 20 as shown in FIG. 1. The support component includes a flexible support table 200 and a base 100. The flexible support table 200 is configured to support the flexible screen 20. The flexible support table 200 includes a central area 210 and first edge areas 220 located on two sides of the central area 210 in a second direction X. The base 100 is arranged on one side of the flexible support table 200 in a first direction Z and configured to support the flexible support table 200. The base 100 includes a first abutting portion 120, and at least part of the first edge area 220 abuts against and between two first abutting portions 120 that are arranged oppositely in a third direction Y. The first direction Z, the second direction X and the third direction Y intersect each other.

The base 100 may be configured in a variety of ways. In one embodiment, the base 100 may be formed from a rigid material such as metal and plastic, such that the base 100 can provide good support for the flexible support table 200.

The flexible support table 200 may be configured in a variety of ways. In one embodiment, the flexible support table 200 may be formed from a flexible material such as silicone, such that the flexible support table 200 has a good deformation capability. The flexible support table 200 may alternatively be formed from another elastic material with deformation capability, as long as the flexible support table 200 has a certain flexibility, and the surface of the flexible support table 200 for supporting the flexible screen 20 can be deformed.

In one embodiment, the surface of the flexible support table 200 for supporting the flexible screen 20 is adapted to the shape of the curved cover plate 10.

One first abutting portion 120, or two or more first abutting portions 120 spaced apart from each other in the second direction X may be provided on the same side of the flexible support table 200.

The support component provided in the embodiments of the present application is configured to support the flexible screen 20 during the lamination of the curved cover plate 10 with the flexible screen 20. The support component includes a flexible support table 200 and a base 100. The flexible support table 200 is configured to support the flexible screen 20, and the base 100 is configured to support the flexible support table 200. The flexible support table 200 includes a central area 210 and first edge areas 220. The first edge areas 220 are more susceptible to deformation. At least part of the first edge area 220 abuts against and between two of the first abutting portions 120 that are arranged oppositely in the third direction Y, and the first abutting portions 120 can provide the first edge area 220 with limiting forces facing each other in the third direction Y, so that the problem of insufficient force exerted by the first edge area 220 on the flexible screen 20 due to excessive deformation of the first edge area can be alleviated, and the problem of lamination bubbles between the curved cover plate 10 and the flexible screen 20 can thus be alleviated.

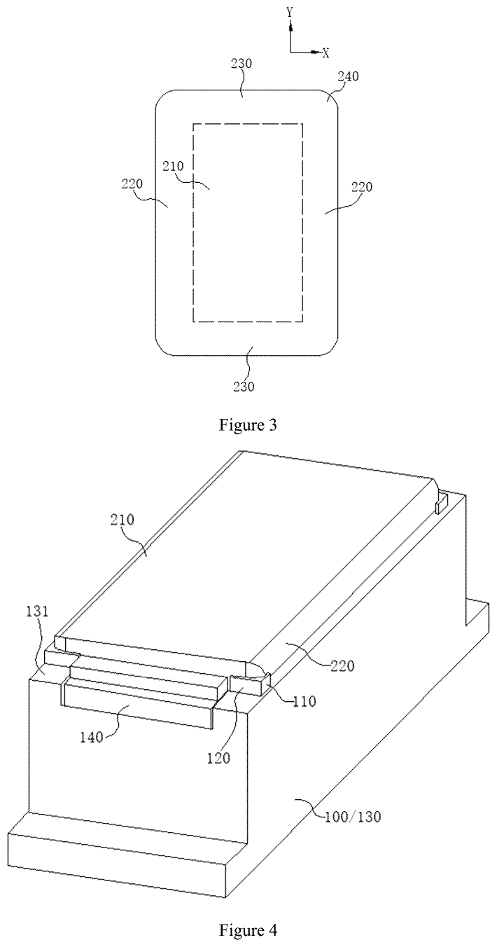

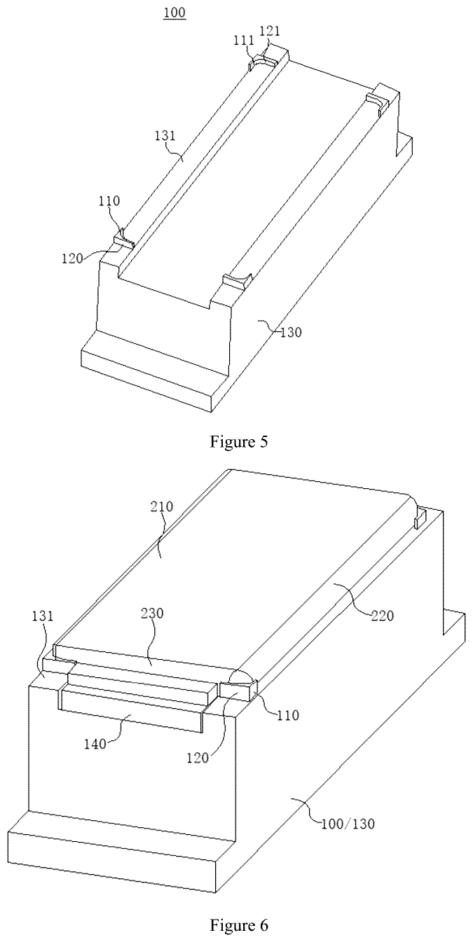

Referring to FIGS. 3 to 5 together, FIG. 3 is a top view of a flexible support table 200 of a support component according to an embodiment of the present application, FIG. 4 is a structural schematic perspective view of a support component according to another embodiment of the present application, and FIG. 5 is a structural schematic perspective view of a base 100 of a support component according to another embodiment of the present application.

In some embodiments, as shown in FIGS. 3 to 5, a surface of the flexible support table 200 for supporting the flexible screen 20 in the first edge area 220 is curved.

In these embodiments, the surface of the flexible support table 200 for supporting the flexible screen 20 in the first edge area 220 is curved, so that the flexible support table 200 support the flexible screen 20 in the first edge area 220 to laminate with the specially-shaped portion 11. It is likely to generate lamination bubbles during the lamination of the specially-shaped portion 11 with the flexible screen 20. The first abutting portions 120 can provide the first edge area 220 with limiting forces facing each other in the third direction Y, so that the problem of insufficient force exerted by the first edge area 220 on the flexible screen 20 due to excessive deformation of the first edge area can be alleviated, and the problem of lamination bubbles between the specially-shaped portion 11 and the flexible screen 20 can thus be alleviated.

In one embodiment, an extension width of the first abutting portion 120 is greater than or equal to the extension width of the first edge area 220 in the second direction X. The first abutting portion 120 has a relatively large size, so that it is possible to alleviate the problem of the first edge area 220 and the first abutting portion 120 being not aligned accurately due to manufacturing errors or alignment errors and the first abutting portion 120 failing to properly limit the first edge area 220. The size of the first abutting portion 120 is large enough so that the first abutting portion 120 can limit the entire first edge area 220 and at least part of the central area 210, thereby better alleviating the problem of excessive deformation of the flexible support table 200.

The number of first edge areas 220 may be set in a variety of ways, the number of first edge areas 220 may be one, and the one first edge area 220 is located on one side of the central area 210.

In some other embodiments, two first edge areas 220 are respectively arranged on two sides of the central area 210, two first abutting portions 120 are arranged on the same side of the flexible support table 200, and each first abutting portion 120 is configured to abut against a respective first edge area 220. That is, each first abutting portion 120 corresponds to one first edge area 220 and is configured to abut against the first edge area 220.

In these embodiments, the flexible support table 200 includes two first edge areas 220, so that the flexible support table 200 can support the flexible screen 20 to laminate with the dual-curved cover plate 10. The two first abutting portions 120 are arranged on the same side of the flexible support table 200, so that each first edge area 220 can be limited by the first abutting portions 120, thereby better alleviating the problem of excessive deformation of the flexible support table 200, and thus better alleviating the problem of lamination bubbles between the curved cover plate 10 and the flexible screen 20.

Referring to FIGS. 3 and 6 together, FIG. 6 is a structural schematic perspective view of a support component according to still another embodiment of the present application.

In some embodiments, as shown in FIGS. 3 and 6, the flexible support table 200 further includes second edge areas 230 located on two sides of the central area 210 in the third direction Y, and bent areas 240 each connecting the first edge area 220 and the second edge area 230. At least part of the bent area 240 is located between two of the first abutting portions 120 that are arranged oppositely in the third direction Y.

In these embodiments, the bent area 240 is arranged closer to the corner of the flexible support table 100, the bent area 240 is more susceptible to deformation, and at least part of the bent area 240 is located between the two first abutting portions 120, so that the first abutting portion 120 can limit the bent area 240, to alleviate the problem of insufficient support force caused by large deformation of the bent area 240, which makes it easy for lamination bubbles to generate between the flexible screen 20 and the curved cover plate 10.

In some embodiments, the base 100 further includes second abutting portions 110, and at least part of the second edge area 230 abuts against and between two of the second abutting portions 110 that are arranged oppositely in the second direction X.

In these embodiments, the flexible support table 200 includes second edge areas 230. The second edge areas 230 are susceptible to deformation. At least part of the second edge area 230 abuts against and between two of the second abutting portions 110 that are arranged oppositely in the second direction X, and the second abutting portions 110 can provide the second edge area 230 with limiting forces facing each other in the second direction X, so that the problem of insufficient force exerted by the second edge area 230 on the flexible screen 20 due to excessive deformation of the second edge area can be alleviated, and the problem of lamination bubbles between the curved cover plate 10 and the flexible screen 20 can thus be alleviated.

In one embodiment, the surface of the flexible support table 200 for supporting the flexible screen 20 in the second edge area 230 is curved, so that the flexible support table 200 support the flexible screen 20 in the second edge area 230 to laminate with the specially-shaped portion 11. It is likely to generate lamination bubbles during the lamination of the specially-shaped portion 11 with the flexible screen 20, and the second abutting portions 110 can provide the second edge area 230 with limiting forces facing each other in the second direction X, thereby alleviating the problem of lamination bubbles between the specially-shaped portion 11 and the flexible screen 20.

In one embodiment, at least part of the bent area 240 abuts against and between two of the second abutting portions 110 that are arranged oppositely in the second direction X. In this way, the second abutting portions 110 can limit the bent areas 240, and the first abutting portions 120 can also limit the bent areas 240. That is, corner portions of the flexible support table 200 are limited on all sides by the second abutting portions 110 and the first abutting portions 120, so that the problem of lamination bubbles being likely to be generated between the curved cover plate 10 and the flexible screen 20 due to insufficient support force caused by the deformability of the bent area 240 can be better alleviated.

In one embodiment, the second edge areas 230 are both located between the two second abutting portions 110 arranged oppositely in the second direction X. That is, both the second edge areas 230 can be stopped by the second abutting portions 110, thereby better alleviating the problem of insufficient support force caused by excessive deformation of the second edge areas 230, and thus better alleviating the problem of lamination bubbles between the specially-shaped portion 11 and the flexible screen 20.

In one embodiment, an extension width of the second abutting portion 110 is greater than or equal to the extension width of the second edge area 230 in the third direction Y. The second abutting portion 110 has a relatively large size, so that it is possible to alleviate the problem of the second edge area 230 and the second abutting portion 110 being not aligned accurately due to manufacturing errors or alignment errors and the second abutting portion 110 failing to properly limit the second edge area 230. The size of the second abutting portion 110 is large enough so that the second abutting portion 110 can limit the entire second edge area 230 and at least part of the central area 210, thereby better alleviating the problem of excessive deformation of the flexible support table 200.

The number of second edge areas 230 may be set in a variety of ways, the number of second edge areas 230 may be one, and the one second edge area 230 is located on one side of the central area 210.

In some other embodiments, two second edge areas 230 are respectively arranged on two sides of the central area 210, two second abutting portions 110 are arranged on the same side of the flexible support table 200, and each second abutting portion 110 is configured to abut against a respective second edge area 230. That is, each second abutting portion 110 corresponds to one second edge area 230 and abuts against the second edge area 230.

In these embodiments, the flexible support table 200 includes two second edge areas 230 and two first edge areas 220, so that the flexible support table 200 can support the flexible screen 20 to laminate with a quad-curved cover plate 10. The two second abutting portions 110 are arranged on the same side of the flexible support table 200, so that each second edge area 230 can be limited by the second abutting portions 110, thereby better alleviating the problem of excessive deformation of the flexible support table 200, and thus better alleviating the problem of lamination bubbles between the curved cover plate 10 and the flexible screen 20.

The base 100 may be configured in a variety of ways. The base 100 may be integrally formed and configured to support and limit the entire flexible support table 200.

In some other embodiments, as shown in FIGS. 4 to 6, the base 100 includes a body 130 and stoppers 140. The body 130 includes support protrusions 131 spaced apart from each other in the second direction X and configured to support the first edge areas 220, and two of the stoppers 140 are spaced apart from each other in the third direction Y and arranged between adjacent two of the support protrusions 131.

In these embodiments, the base 100 includes the body 130 and the stoppers 140, the body 130 includes the support protrusions 131 spaced apart from each other in the second direction X, and the support protrusions 131 are, for example, configured to provide support to first arc-shaped areas of the flexible support table 200. The stoppers 140 are arranged between two support protrusions 131, and the two stoppers 140 are spaced apart from each other in the third direction Y. The two stoppers 140 may for example be configured to provide support to the second edge areas 220 of the flexible support table 200, or the two stoppers 140 are configured to provide the flexible support table 200 with limiting forces facing each other in the third direction Y. The base 100 can be adapted to flexible support tables 200 of different sizes by changing the distance between the two stoppers 140, so that the adaptability of the base 100 can be improved. Furthermore, it is also possible to tolerate manufacturing errors of the flexible support table 200 in the third direction Y by changing the distance between the two stoppers 140.

In one embodiment, the body 130 further includes a support recess between the two support protrusions 131. The support recess is formed by recessing relative to the support protrusions 131 in a direction away from the flexible support table 200, and the stoppers 140 may be arranged on the support recess. In one embodiment, the support recess is configured to support the central area 210 of the flexible support table 200.

When the base 100 includes a body 130 and stoppers 140, as shown in FIGS. 4 to 6, the support protrusion 131 is provided with both the second abutting portion 110 and the first abutting portion 120. For example, the second abutting portion 110 and the first abutting portion 120 may be provided integrally with the support protrusion 131.

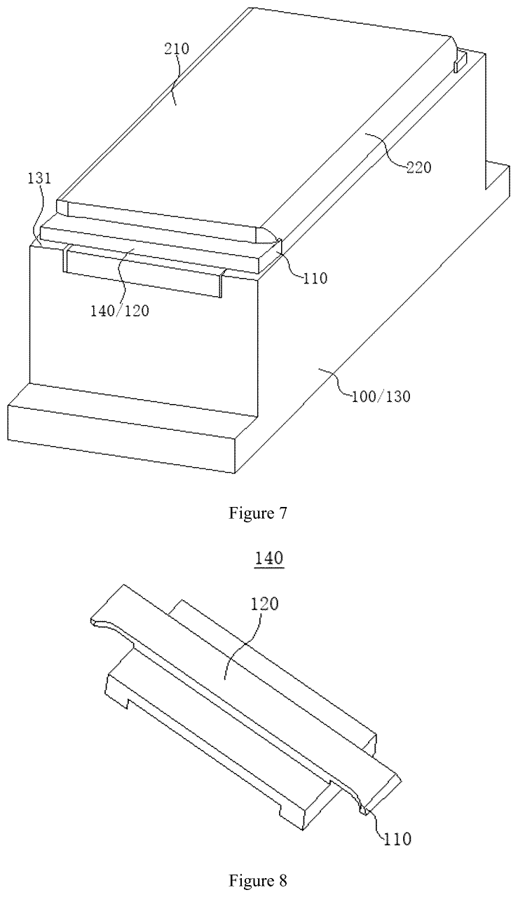

In some embodiments, referring to FIGS. 7 and 8 together, FIG. 7 is a structural schematic perspective view of a support component according to still another embodiment of the present application, and FIG. 8 is a structural schematic view of a stopper 140 of a support component according to still another embodiment of the present application. As shown in FIGS. 7 and 8, the stopper 140 is provided with the second abutting portion 110 and the first abutting portion 120. For example, the second abutting portion 110 and the first abutting portion 120 may be provided integrally with the stopper 140. One of the support protrusion 131 and the stopper 140 is provided with the second abutting portion 110 and the first abutting portion 120, so that the structure of the base 100 can be simplified, thereby facilitating the manufacturing and formation of the base 100.

As shown in FIGS. 2 to 8, the second abutting portion 110 and the first abutting portion 120 can limit the flexible support table 200 at an outer periphery of the flexible support table 200.

In some embodiments, at least one of the second abutting portion 110 and the first abutting portion 120 is located at the outer periphery of the flexible support table 200. For example, the second abutting portion 110 and the first abutting portion 120 are both located at the outer periphery of the flexible support table 200. When the flexible support table 200 is limited from the outer periphery, the flexible support table 200 does not need to make changes in shape, so that the shape and structure of the flexible support table 200 can be simplified, thereby facilitating the manufacturing and formation of the flexible support table 200.

When both the second abutting portion 110 and the first abutting portion 120 limit the flexible support table 200 from the outer periphery of the flexible support table 200, the number of second abutting portions 110 is for example four, two of the second abutting portions 110 being in one group. The two groups of second abutting portions 110 are respectively arranged on two sides of the flexible support table 200 in the second direction X, and two second abutting portions 110 of the same group located on the same side of the flexible support table 200 in the second direction X are spaced apart from each other in the third direction Y. The number of first abutting portions 120 is for example four, two of the first abutting portions 120 being in one group. The two groups of first abutting portions 120 are respectively arranged on two sides of the flexible support table 200 in the third direction Y, and two first abutting portions 120 of the same group located on the same side of the flexible support table 200 in the third direction Y are spaced apart from each other in the second direction X.

In one embodiment, the four second abutting portions 110 and the four first abutting portions 120 are located at four corners of the orthographic projection of the flexible support table 200 in the first direction Z, and the second abutting portion 110 and the first abutting portion 120 adjacent to each other may be provided integrally to further simplify the structure of the base 100.

In one embodiment, the second abutting portion 110 includes a first stop surface 111 facing the flexible support table 200, the first abutting portion 120 includes a second stop surface 121 facing the flexible support table 200, and the first stop surface 111 and the second stop surface 121 adjacent to each other are connected in a smooth transition. The scratching of the flexible support table 200 by the second abutting portion 110 and the first abutting portion 120 can be reduced, to prolong the service life of the flexible support table 200.

In one embodiment, when the second abutting portion 110 and the first abutting portion 120 limit the flexible support table 200 from the outer periphery of the flexible support table 200, the extension height of the second abutting portion 110 and/or the first abutting portion 120 in the first direction Z is greater than or equal to 2 mm, to alleviate the problem of the insufficient limiting force provided to the flexible support table 200 due to the insufficient height of the second abutting portion 110 and/or the first abutting portion 120.

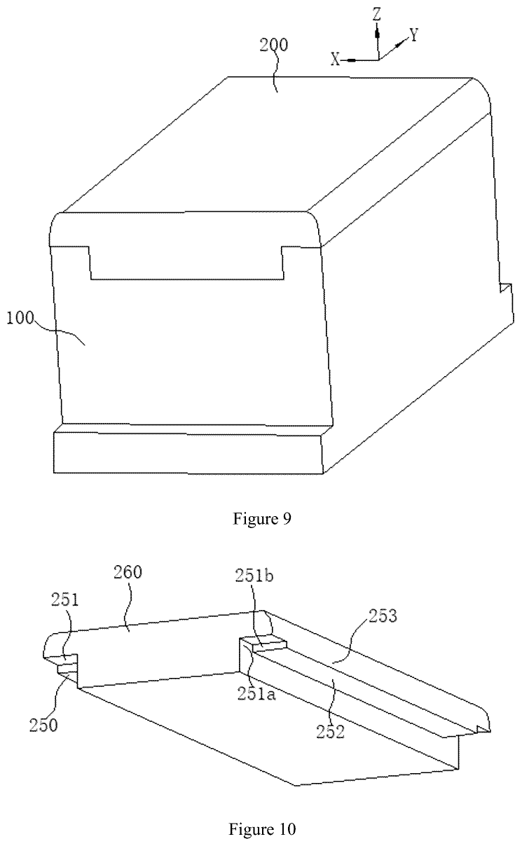

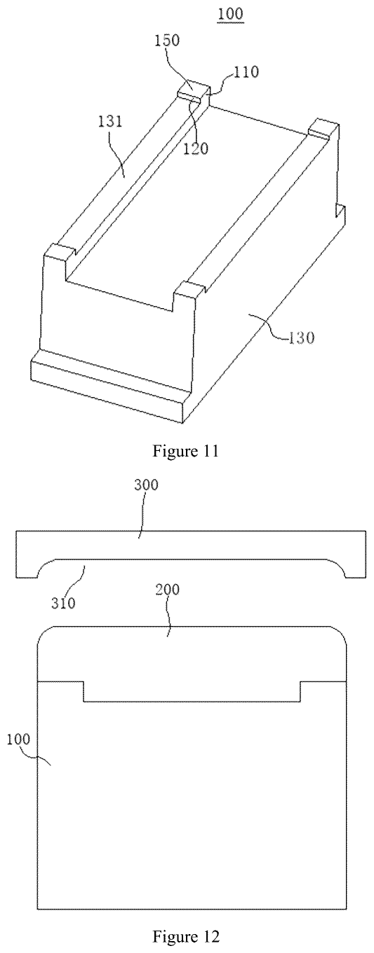

Referring to FIGS. 9 to 11 together, FIG. 9 is a structural schematic perspective view of a support component according to yet another embodiment of the present application, FIG. 10 is a structural schematic perspective view of a flexible support table 200 of a support component according to yet another embodiment of the present application, and FIG. 11 is a structural schematic perspective view of a base 100 of a support component according to yet another embodiment of the present application.

In some embodiments, as shown in FIGS. 9 to 11, the flexible support table 200 includes a mating portion 250, and a support portion 260 arranged on a side of the mating portion 250 facing away from the base 100 and configured to support the flexible screen 20, the second abutting portion 110 and the first abutting portion 120 abut against the mating portion 250, and orthographic projections of the second abutting portion 110 and the first abutting portion 120 in the first direction Z at least partially overlap an orthographic projection of the support portion 260 in the first direction Z.

In these embodiments, the flexible support table 200 includes the mating portion 250 and the support portion 260, the second abutting portion 110 and the first abutting portion 120 are configured to abut against the mating portion 250, and the second abutting portion 110 and the first abutting portion 120 limit the deformation of the flexible support table 200 by providing limiting forces to the mating portion 250. Furthermore, the orthographic projections of the second abutting portion 110 and the first abutting portion 120 in the first direction Z at least partially overlapping the orthographic projection of the support portion 260 in the first direction Z means that at least part of the second abutting portion 110 and at least part of the first abutting portion 120 are located on a side of the support portion 260 facing the base 100, and at least part of the second abutting portion 110 and at least part of the first abutting portion 120 can provide support to the support portion 260, to increase the force exerted by the support portion 260 on the flexible screen 20, thereby better alleviating the problem of lamination bubbles between the flexible screen 20 and the curved cover plate 10.

Therefore, during the lamination of the curved cover plate 10 with the flexible screen 20, the second abutting portion 110 and the first abutting portion 120 in the embodiments of the present application can not only limit the deformation of the flexible support table 200 by applying a force to the mating portion 250, to increase the force exerted by the flexible support table 200 on the flexible screen 20; but can also increase the force exerted by the support portion 260 on the flexible screen 20 by providing support to the support portion 260, to further alleviate the problem of lamination bubbles between the flexible screen 20 and the curved cover plate 10.

In one embodiment, the mating portion 250 may be located in the first edge area 220 and/or the second edge area 230.

In some embodiments, the mating portion 250 includes a recess 251 formed by recessing toward the support portion 260. The recess 251 includes a first abutting surface 251a and a second abutting surface 251b. The base 100 includes a body 130 and a boss 150 arranged at the body 130 and received in the recess 251, the second abutting portion 110 is a surface of the boss 150 that abuts against the first abutting surface 251a, and the first abutting portion 120 is the surface of the boss 150 that abuts against the second abutting surface 251b.

The first abutting surface 251a and the second abutting surface 251b are surfaces of the flexible support table 200 facing the recess 251.

In these embodiments, the mating portion 250 is provided with a recess 251, and the base 100 is provided with a boss 150. The boss 150 is located in the recess 251 to provide support to the support portion 260. The boss 150 is provided with the second abutting portion 110 and the first abutting portion 120, and the cooperation of the boss 150 and the recess 251 can also provide the mating portion 250 with limiting forces in the second direction X and the third direction Y.

As described above, when the base 100 includes the support protrusion 131, the boss 150 may be arranged at the support protrusion 131. When the number of second abutting portions 110 and the number of first abutting portions 120 are both four, the number of bosses 150 may be four, and the four bosses 150 are arranged corresponding to four corners of the flexible support table 200. That is, two of the bosses 150 are spaced apart from each other in the third direction Y on the support protrusion 131.

In some embodiments, an orthographic projection of the boss 150 in the first direction Z is located within the orthographic projection of the support portion 260 in the first direction Z. In this way, the boss 150 can provide better support to the support portion 260, and can reduce the size of the boss 150, simplifying the structure of the base 100.

As described above, the flexible support table 200 includes the central area 210, the first edge areas 220 and the second edge areas 230, the flexible support table 200 further includes the bent areas 240 each connecting the first edge area 220 and the second edge area 230, and the recess 251 is located in the bent area 240.

In these embodiments, the shape of the surface of the flexible support table 200 in the bent area 240 is more complex, and it is more likely to generate lamination bubbles when the flexible screen 20 supported by the bent area 240 is laminated with the curved cover plate 10. The recess 251 is located in the bent area 240, and the corresponding boss 150 can thus support the support portion 260 in the bent area 240, to increase the force exerted by the support portion 260 in the bent area 240 on the flexible screen 20, thereby better alleviating the problem of lamination bubbles being likely to be generated between the flexible screen 20 supported by the bent area 240 and the curved cover plate 10.

In some embodiments, the mating portion 250 includes a bottom surface 252 facing the base 100 and a side surface 253 connected to a peripheral side of the bottom surface 252, and at least part of an opening of the recess 251 is located at the side surface 253.

In these embodiments, the opening of the recess 251 faces the base 100 and is partially located at the side surface 253, that is, the recess 251 is provided near a top corner of the flexible support table 200, so that the problem of lamination bubbles being likely to be generated when the flexible screen 20 is laminated with the curved cover plate 10 at the top corner of the flexible support table 200 can be better alleviated.

In one embodiment, a depth of the recess 251 that extends in the first direction Z is greater than or equal to 1 mm, and/or a height of the boss 150 that extends in the first direction Z is greater than or equal to 1 mm, to alleviate the problem of insufficient support force caused by insufficient height of the boss 150, thereby ensuring that the support portion 260 can provide sufficient support to the flexible screen 20.

The depth of the recess 251 that extends in the first direction Z is the distance between the bottom wall surface (i.e., the second abutting surface 251b) of the recess 251 and the bottom surface 252 in the first direction Z. The height of the boss 150 is the height of the boss 150 protruding from the body 130 in the first direction Z. When the boss 150 is arranged at the support protrusion 131, the height of the boss 150 is the height of the boss 150 protruding from the support protrusion 131 in the first direction Z.

As described above, the number of second abutting portions 110 may be two or more. In some embodiments, as shown in FIGS. 2 to 8, two of the second abutting portions 110 are spaced apart from each other in the third direction Y and arranged on the same side of the flexible support table 200, and each of the second abutting portions 110 is provided integrally with the first abutting portion 120 adjacent to the second abutting portion. When the two second abutting portions 110 are spaced apart from each other in the third direction Y and arranged on the same side of the flexible support table 200 in the second direction X, each second abutting portions 110 is close to the respective first abutting portion 120, so that the integral provision of the second abutting portion 110 with the adjacent first abutting portion 120 can simplify the structure and shape of the base 100.

In one embodiment, the first abutting portion 120 is formed by extending in the second direction X and integrally connected between the two second abutting portions 110, at which time part of the first abutting portion 120 may be also used as the stopper 140 described above, further simplifying the structure and shape of the base 100.

In some embodiments, two of the first abutting portions 120 are arranged on the same side of the flexible support table 200, the two first abutting portions 120 on the same side of the flexible support table 200 are spaced apart from each other in the second direction X, and each first abutting portion 120 is integrally formed with the second abutting portion 110 adjacent to the first abutting portion. For example, the first abutting portion 120 and the second abutting portion 110 may be combined to form an L-shaped structure to limit the flexible support table 200 in two directions. The L-shaped structure can be integrally formed with the support protrusion 131 described above.

Referring to FIG. 12, FIG. 12 is a structural schematic view of a lamination device according to an embodiment of the present application.

As shown in FIG. 12, in a second aspect, the embodiments of the present application further provide a lamination device configured to laminate a curved cover plate 10 with a flexible screen 20. The lamination device includes a support component according to any of the above embodiments of the first aspect, and a pressing table 300. The pressing table 300 is arranged on one side of the support component, and the pressing table 300 has a receiving recess 310 for receiving the curved cover plate 10. An opening of the receiving recess 310 faces the support component. Since the lamination device according to the embodiments of the present application includes the support component as described above, the lamination device of the embodiments of the present application has the beneficial effects of the support component as described above, which will not be repeated herein.

What is claimed is:

1. A support component for laminating a curved cover plate with a flexible screen, the support component comprising:
a flexible support table configured to support the flexible screen; and
a base arranged on a side of the flexible support table in a first direction and configured to support the flexible support table,
wherein the flexible support table comprises a central area and first edge areas located on two sides of the central area in a second direction, the base comprises first abutting portions, and at least part of the first edge area abuts against and between two of the first abutting portions arranged oppositely in a third direction, the first direction, the second direction, and the third direction intersecting each other.

2. The support component according to claim 1, wherein the flexible support table further comprises second edge areas located on two sides of the central area in the third direction, and bent areas each connecting the first edge area and the second edge area, at least part of the bent area being located between two of the first abutting portions that are arranged oppositely in the third direction.

3. The support component according to claim 2, wherein an extension width of the first abutting portion is greater than or equal to the extension width of the first edge area in the second direction.

4. The support component according to claim 2, wherein the two first edge areas are arranged on the two sides of the central area, two of the first abutting portions are arranged on the same side of the flexible support table in the third direction, and each of the first abutting portions corresponds to one of the first edge areas and is configured to abut against the first edge area.

5. The support component according to claim 2, wherein the base comprises second abutting portions, and at least part of the second edge area abuts against and between two of the second abutting portions arranged oppositely in the second direction;
and a surface of the flexible support table for supporting the flexible screen in the second edge area is curved.

6. The support component according to claim 5, wherein at least part of the bent area abuts against and between two of the second abutting portions that are arranged oppositely in the second direction;
and an extension width of the second abutting portion is greater than or equal to the extension width of the second edge area in the third direction;
and the two second edge areas are arranged on the two sides of the central area, two of the second abutting portions are arranged on the same side of the flexible support table, and each of the second abutting portions corresponds to one of the second edge areas and is configured to abut against the second edge area.

7. The support component according to claim 5, wherein the base comprises a body and stoppers, the body comprising support protrusions spaced apart from each other in the second direction and configured to support the first edge areas, two of the stoppers being spaced apart from each other in the third direction and arranged between adjacent two of the support protrusions, and the support protrusion is provided with both the second abutting portion and the first abutting portion, or the stopper is provided with both the second abutting portion and the first abutting portion.

8. The support component according to claim 5, wherein at least one of the second abutting portion and the first abutting portion is located at an outer periphery of the flexible support table.

9. The support component according to claim 8, wherein the second abutting portion and the first abutting portion are both located at the outer periphery of the flexible support table;
and an extension height of the second abutting portion and the first abutting portion is greater than or equal to 2 mm in the first direction.

10. The support component according to claim 9, wherein the second abutting portion comprises a first stop surface facing the flexible support table, the first abutting portion comprises a second stop surface facing the flexible support table, and the first stop surface and the second stop surface adjacent to each other are connected in a smooth transition.

11. The support component according to claim 8, wherein the flexible support table comprises a mating portion, and a support portion arranged on a side of the mating portion facing away from the base and configured to support the flexible screen, the second abutting portion and the first abutting portion abut against the mating portion, and orthographic projections of the second abutting portion and the first abutting portion in the first direction at least partially overlap an orthographic projection of the support portion in the first direction.

12. The support component according to claim 11, wherein
the mating portion comprises a recess formed by recessing toward the support portion, the recess comprising a first abutting surface and a second abutting surface; and
the base comprises a body and a boss arranged at the body and received in the recess, the second abutting portion is a surface of the boss that abuts against the first abutting surface, and the first abutting portion is a surface of the boss that abuts against the second abutting surface.

13. The support component according to claim 12, wherein an orthographic projection of the boss in the first direction is located within the orthographic projection of the support portion in the first direction.

14. The support component according to claim 12, wherein the recess is located in the bent area.

15. The support component according to claim 12, wherein the mating portion comprises a bottom surface facing the base and a side surface connected to a peripheral side of the bottom surface, and at least part of an opening of the recess is located at the side surface.

16. The support component according to claim 12, wherein a depth of the recess extended in the first direction is greater than or equal to 1 mm, and a height of the boss extended in the first direction is greater than or equal to 1 mm.

17. The support component according to claim 5, wherein two of the second abutting portions spaced apart from each other in the third direction are arranged on the same side of the flexible support table in the second direction, and each of the second abutting portions is provided integrally with the first abutting portion adjacent to the second abutting portion.

18. The support component according to claim 17, wherein the first abutting portion is formed by extending in the second direction and integrally connected between two of the second abutting portions, or two of the first abutting portions are spaced apart from each other on the same side of the flexible support table, and each of the first abutting portions is integrally formed with the second abutting portion adjacent to the first abutting portion.

19. The support component according to claim 1, wherein a surface of the flexible support table for supporting the flexible screen in the first edge area is curved.

20. A lamination device configured to laminate a curved cover plate with a flexible screen, the lamination device comprising:
a support component of claim 1, and
a pressing table arranged on one side of the support component, the pressing table comprising a receiving recess for receiving the curved cover plate, and an opening of the receiving recess facing the support component.
